(19) United States
(12) Patent Application Publication
(10) Pub. No.: US 2021/0343041 A1
(43) Pub. Date: Nov. 4, 2021

(54) METHOD AND APPARATUS FOR OBTAINING POSITION OF TARGET, COMPUTER DEVICE, AND STORAGE MEDIUM

(71) Applicant: TENCENT TECHNOLOGY (SHENZHEN) COMPANY LIMITED, Shenzhen (CN)

(72) Inventors: Ning WANG, Shenzhen (CN); Yibing SONG, Shenzhen (CN); Wei LIU, Shenzhen (CN)

(73) Assignee: TENCENT TECHNOLOGY (SHENZHEN) COMPANY LIMITED, Shenzhen (CN)

(21) Appl. No.: 17/377,302

(22) Filed: Jul. 15, 2021

Related U.S. Application Data
(63) Continuation of application No. PCT/CN2020/087361, filed on Apr. 28, 2020.

(30) Foreign Application Priority Data
May 6, 2019 (CN) 201910371250.9

(51) Int. Cl. G06T 7/73; G06T 7/00; G06N 20/00

(52) U.S. Cl. CPC G06T 7/74; G06T 2207/20081; G06N 20/00; G06T 7/97

(57) ABSTRACT

A method for obtaining a position of a target is provided. A plurality of frames of images is received. A first image in the plurality of frames of images includes a to-be-detected target. A position obtaining model is invoked, a model parameter of the position obtaining model is obtained through training based on a first position of a selected target in a first sample image and a second position of the selected target in the first sample image. The second position is predicted based on a third position of the selected target in a second sample image. The third position is predicted based on the first position. A position of the to-be-detected target in a second image is determined based on the model parameter and a position of the to-be-detected target in the first image via the position obtaining model.

### RELATED APPLICATIONS

This application is a continuation of International Application No. PCT/CN2020/087361, entitled “METHOD AND APPARATUS FOR ACQUIRING POSITIONS OF TARGET, AND COMPUTER DEVICE AND STORAGE MEDIUM” and filed on Apr. 28, 2020, which claims priority to Chinese Patent Application No. 201910371250.9, entitled “METHOD AND APPARATUS FOR OBTAINING POSITION OF TARGET, COMPUTER DEVICE, AND STORAGE MEDIUM” and filed on May 6, 2019. The entire disclosure of the prior applications are hereby incorporated by reference in their entirety.

### FIELD OF THE TECHNOLOGY

The present disclosure relates to the field of computer technologies, including to a technology for obtaining a position of a target.

### BACKGROUND OF THE DISCLOSURE

With the development of computer technologies, people can generally process images to obtain various analysis results. For example, a plurality of frames of images may be processed. The plurality of frames of images may be processed according to a target determined in one frame of image, and positions of the target in other images may be obtained, to track the target.

At present, in a method for obtaining a position of a target, a target is usually given in one frame of image, and a plurality of frames of images are processed based on a target tracking algorithm, to obtain positions of the target in the plurality of frames of images. When sample images are used to train the target tracking algorithm, a real position of a target needs to be annotated in each frame of sample image. According to the target tracking algorithm, calculation is performed on each frame of sample image to determine a predicted position of the target, and the target tracking algorithm is trained based on the predicted position of the target and the annotated real position of the target.

In the foregoing method for obtaining a position of a target, the real position of the target needs to be manually annotated in each frame of sample image, which requires high labor costs and a cumbersome image processing process. Therefore, the efficiency of the method for obtaining a position of a target is low.

### SUMMARY

Embodiments of the present disclosure include methods and apparatuses for obtaining a position of a target, computer devices, and non-transitory computer-readable storage mediums, to resolve problems of high labor costs, a cumbersome processing process, and low efficiency in the related art. The technical solutions can include the following.

In an aspect, a method for obtaining a position of a target is provided. In the method, a plurality of frames of images is receive. A first image in the plurality of frames of images includes a to-be-detected target. A position obtaining model is invoked. A model parameter of the position obtaining model is obtained through training based on a first position of a selected target in a first sample image in a plurality of frames of sample images and a second position of the selected target in the first sample image. The second position is predicted based on a third position of the selected target in a second sample image in the plurality of frames of sample images. The third position is predicted based on the first position. The second sample image is different from the first sample image in the plurality of frames of sample images. A position of the to-be-detected target in a second image is determined based on the model parameter and a position of the to-be-detected target in the first image via the position obtaining model. The second image is different from the first image in the plurality of frames of images.

In an aspect, a method for obtaining a position of a target is provided. A plurality of frames of sample images is obtained. An initial model is invoked. Based on a first position of a selected target in a first sample image in the plurality of frames of sample images according to the initial model, a third position of the selected target in a second sample image is obtained. A second position of the selected target in the first sample image is obtained based on the third position of the selected target in the second sample image. A model parameter of the initial model is adjusted based on the first position and the second position, to obtain a position obtaining model. The selected target is obtained by randomly selecting a target area in the first sample image by the initial model. The second sample image is different from the first sample image in the plurality of frames of sample images. The position obtaining model is invoked when a plurality of frames of images is obtained, and positions of a to-be-detected target in the plurality of frames of images are determined according to the position obtaining model.

In an aspect, an apparatus for obtaining a position of a target is provided. The apparatus includes processing circuitry configured to receive a plurality of frames of images. A first image in the plurality of frames of images includes a to-be-detected target. The processing circuitry is configured to invoke a position obtaining model. A model parameter of the position obtaining model is obtained through training based on a first position of a selected target in a first sample image in a plurality of frames of sample images and a second position of the selected target in the first sample image. The second position is predicted based on a third position of the selected target in a second sample image in the plurality of frames of sample images. The third position is predicted based on the first position. The second sample image is different from the first sample image in the plurality of frames of sample images. A position of the to-be-detected target in a second image is determined based on the model parameter and a position of the to-be-detected target in the first image via the position obtaining model. The second image being different from the first image in the plurality of frames of images.

In an aspect, an apparatus for obtaining a position of a target is provided. The processing circuitry is configured to obtain a plurality of frames of sample images. The processing circuitry is configured to invoke an initial model, obtain, based on a first position of a selected target in a first sample image in the plurality of frames of sample images according to the initial model, a third position of the selected target in a second sample image, obtain a second position of the selected target in the first sample image based on the third position of the selected target in the second sample image, and adjust a model parameter of the initial model based on the first position and the second position, to obtain a position obtaining model. The selected target is obtained by randomly selecting a target area in the first sample image by the initial model. The second sample image is different from the first sample image in the plurality of frames of sample images. Further the processing circuitry is configured to invoke the position obtaining model when a plurality of frames of images is obtained, and determine positions of a to-be-detected target in the plurality of frames of images according to the position obtaining model.

In an aspect, a computer device is provided, including one or more processors and one or more memories storing at least one instruction, the instruction being loaded and executed by the one or more processors to implement the operations performed in one or more of the methods for obtaining a position of a target.

In an aspect, a non-transitory computer-readable storage medium is provided. The non-transitory computer-readable storage medium stores instructions which when executed by a processor cause the processor to perform one or more of the methods for obtaining a position of a target.

In some embodiments of the present disclosure, the plurality of frames of images are processed by using the position obtaining model obtained through training, to obtain the positions of the target in the plurality of frames of images. The position obtaining model may be obtained through training in forward and backward processes. Through the forward process, the third position of the selected target in the second sample image may be predicted according to the first position of the selected target in the first sample image; and through the backward process, the second position of the selected target in the first sample image may be predicted according to the third position. Because the selected target is randomly selected from the first sample image, and the selected position is determined, the first position is a real position of the selected target. Based on the first position and the second position of the selected target in the first sample image, the accuracy of the model parameter of the initial model may be reflected by an error value between the first position and the second position. Therefore, the initial model may be trained according to the first position and the second position without manual annotation by a person skilled in the art, which can effectively reduce labor costs and improve efficiency of model training. The image processing process is simple, effectively improving efficiency of the entire process of obtaining a position of a target.

### BRIEF DESCRIPTION OF THE DRAWINGS

To describe the technical solutions in the embodiments of the present disclosure more clearly, the following briefly describes the accompanying drawings required for describing the embodiments. The accompanying drawings in the following description show merely some embodiments of the present disclosure, and a person of ordinary skill in the art may still derive other drawings from these accompanying drawings.

FIG. 1 is a schematic diagram of an implementation environment of a method for obtaining a position of a target according to an embodiment of the present disclosure.

FIG. 2 is a flowchart of a method for training a position obtaining model according to an embodiment of the present disclosure.

FIG. 3 is a schematic diagram of a process of obtaining a plurality of frames of sample images according to an embodiment of the present disclosure.

FIG. 4 is a schematic diagram of training data according to an embodiment of the present disclosure.

FIG. 5 is a flowchart of training a position obtaining model according to an embodiment of the present disclosure.

FIG. 6 is a comparison diagram of obtained different sample image sets according to an embodiment of the present disclosure.

FIG. 7 is a flowchart of a method for obtaining a position of a target according to an embodiment of the present disclosure.

FIG. 8 is a flowchart of a method for obtaining a position of a target according to an embodiment of the present disclosure.

FIG. 9 is a schematic structural diagram of an apparatus for obtaining a position of a target according to an embodiment of the present disclosure.

FIG. 10 is a schematic structural diagram of an apparatus for obtaining a position of a target according to an embodiment of the present disclosure.

FIG. 11 is a schematic structural diagram of a terminal according to an embodiment of the present disclosure.

FIG. 12 is a schematic structural diagram of a server according to an embodiment of the present disclosure.

### DESCRIPTION OF EMBODIMENTS

To make the objectives, technical solutions, and advantages of the present disclosure clearer, the following further describes exemplary implementations of the present disclosure in further detail with reference to the accompanying drawings.

FIG. 1 shows an implementation environment of a method for obtaining a position of a target according to an embodiment of the present disclosure. Referring to FIG. 1, the implementation environment may include at least one computer device. The plurality of computer devices may implement data exchange in a wired connection manner, or may implement data exchange in a network connection manner. This is not limited in this embodiment of the present disclosure.

In a possible implementation, the at least one computer device may include a computer device 101 and a computer device 102, where the computer device 101 may be configured to process a plurality of frames of images, to obtain positions of a target in the plurality of frames of images. The computer device 102 may be configured to acquire a plurality of frames of images, or shoot a video, and send an acquired image or video to the computer device 101, and the computer device 101 processes the image or video to track the target.

In another possible implementation, the at least one computer device may include only the computer device 101. The computer device may acquire a plurality of frames of images, shoot a video, or the like, to further process the acquired plurality of frames of images, or a plurality of frames of images obtained after processing such as image extraction is performed on the captured video, or a plurality of frames of images downloaded, or a plurality of frames of images obtained after processing such as image extraction is performed on a downloaded video, to determine positions of a target in the plurality of frames of images, thereby implementing target tracking. An application scenario of the method for obtaining a position of a target is not limited in this embodiment of the present disclosure.

The method for obtaining a position of a target may be applied to various target tracking scenarios, for example, to analyze a scenario in an image or video, to track a target by using a monitoring device, or a human-computer interaction scenario. The method for obtaining a position of a target provided in this embodiment of the present disclosure is not limited to these scenarios, and may include other scenarios, which are not listed herein. A target may be a person or a thing. In different application scenarios, the target may be different. For example, in an indoor monitoring scenario, the target may be a human, and in a road monitoring scenario, the target may be a car. Both the computer device 101 and the computer device 102 may be provided as terminals, or may be provided as servers. This is not limited in this embodiment of the present disclosure.

It is to be emphasized that, the method for obtaining a position of a target provided in this embodiment of this disclosure may be implemented based on artificial intelligence (AI). AI is a theory, method, technology, and application system that uses a digital computer or a machine controlled by the digital computer to simulate, extend, and expand human intelligence, perceive an environment, obtain knowledge, and use knowledge to obtain an optimal result. In other words, AI is a comprehensive technology in computer science and attempts to understand the essence of intelligence and produce a new intelligent machine that can react in a manner similar to human intelligence. AI is to study the design principles and implementation methods of various intelligent machines, to enable the machines to have the functions of perception, reasoning, and decision-making.

The AI technology is a comprehensive discipline, and relates to a wide range of fields including both hardware-level technologies and software-level technologies. The basic AI technologies generally include technologies such as a sensor, a dedicated AI chip, cloud computing, distributed storage, a big data processing technology, an operating/interaction system, and electromechanical integration. AI software technologies mainly include several major directions such as a computer vision (CV) technology, a speech technology, a natural language processing technology, and machine learning (ML)/deep learning.

The solutions provided in the embodiments of this disclosure include technologies such as ML/deep learning of AI and CV. In this embodiment of this disclosure, for example, a position obtaining model is trained through ML, and then positions of a to-be-detected target in a plurality of frames of images are determined by using the position obtaining model obtained through training.

ML is a multi-field interdiscipline, and relates to a plurality of disciplines such as the probability theory, statistics, the approximation theory, convex analysis, and the algorithm complexity theory. ML specializes in studying how a computer simulates or implements a human learning behavior to obtain new knowledge or skills, and reorganize an existing knowledge structure, so as to keep improving its performance. ML is the core of AI, is a basic way to make the computer intelligent, and is applied to various fields of AI. ML and deep learning generally include technologies such as an artificial neural network, a belief network, reinforcement learning, transfer learning, inductive learning, and learning from demonstrations.

In a process of training a position obtaining model or obtaining a position of a target, the CV technology may be further involved. The CV is a science that studies how to use a machine to “see”, and furthermore, that uses a camera and a computer to replace human eyes to perform machine vision such as recognition, tracking, and measurement on a target, and further perform graphic processing, so that the computer processes the target into an image more suitable for human eyes to observe, or an image transmitted to an instrument for detection. As a scientific discipline, CV studies related theories and technologies and attempts to establish an AI system that can obtain information from images or multidimensional data.

In this embodiment of this disclosure, for example, technologies such as image processing and image semantic understanding in the CV technology are involved. For example, after an image such as a to-be-recognized image or a training sample is obtained, image processing is performed, for example, target selection. In another example, image feature extraction is performed by using the image semantic understanding technology.

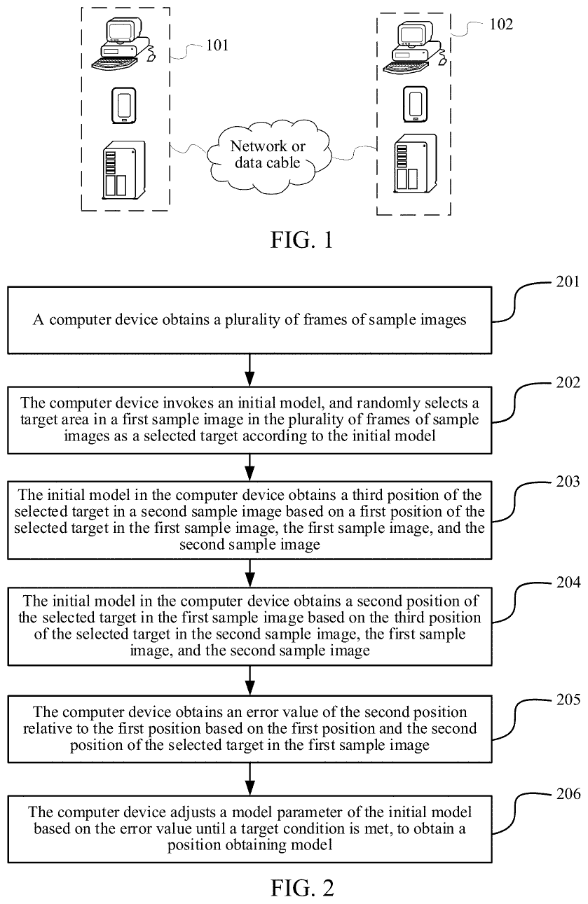

FIG. 2 is a flowchart of a method for training a position obtaining model according to an embodiment of the present disclosure. The method for training a position obtaining model may be applied to a computer device, and the computer device may be provided as a terminal, or may be provided as a server. This is not limited in this embodiment of the present disclosure. Referring to FIG. 2, the method may include the following steps.

In step 201, a computer device obtains a plurality of frames of sample images.

In this embodiment of the present disclosure, the computer device may obtain a plurality of frames of sample images and train an initial model based on the plurality of frames of sample images, to obtain a position obtaining model. The position obtaining model may process a plurality of frames of images based on a to-be-detected target determined in one of the plurality of frames of images, to obtain a position of the to-be-detected target in each of the plurality of frames of images.

The computer device may obtain a plurality of frames of sample images and use the plurality of frames of sample images as training samples to train the initial model. In this embodiment of the present disclosure, there is no need for a person skilled in the art to manually annotate a target in the plurality of frames of sample images, and the computer device may directly process the plurality of frames of sample images and train the initial model, thereby implementing a process of unsupervised learning, reducing labor costs, and improving efficiency of model training.

In a possible implementation, the plurality of frames of sample images include a plurality of sample image sets, and each sample image set includes one frame of first sample image and at least one frame of second sample image, the second sample image being a sample image other than the first sample image.

For example, the first sample image may be used as a template image, that is, a sample image used for obtaining a selected target; and the second sample image may be used as a search image. The search image is a sample image used for searching for a position of the selected target, that is, the position of the selected target in the search image may be obtained based on the selected target in the template image. In this implementation, each sample image set is a training sample set, a plurality of frames of sample images (one frame of first sample image and at least one frame of second sample image) in each sample image set include the same selected target, and the computer device may track the selected target, to obtain a position of the selected target in each of the plurality of frames of sample images.

For example, each sample image set may include one frame of first sample image and two frames of second sample images. For example, three frames may be selected from 10 adjacent frames of a video file, where one frame is used as the first sample image, and the other two frames are used as the second sample images. That is, it is assumed that the selected target does not move out of a specific area within a short time of the 10 frames. Obtaining a plurality of frames of second sample images can avoid a high error value of a result obtained by chance during processing based on one frame of first sample image and one frame of second sample image. However, in fact, intermediate data during the processing is wrong. Such an accidental situation can be reduced by increasing training samples, and an error accumulation can be increased for error correction, which can improve the stability and the error value of the position obtaining model.

The process of obtaining the plurality of frames of sample images by the computer device may include various manners. In one respect, the plurality of frames of sample images may be stored in the computer device, or may be stored in another computer device. The computer device may obtain the plurality of frames of sample images from a local storage file, or may send an image obtaining request to another computer device. The another computer device sends the plurality of frames of sample images to the computer device based on the image obtaining request, so that the computer device obtains the plurality of frames of sample images. This is not limited in this embodiment of the present disclosure.

In another aspect, the computer device may directly obtain the plurality of frames of sample images, or may extract the plurality of frames of sample images from a video file. The plurality of frames of sample images may be stored in an image database, and the computer device may obtain the plurality of frames of sample images from the image database. The video file in which the plurality of frames of sample images are located may be stored in a video database, and the computer device may obtain at least one video file from the video database, to extract the plurality of frames of sample images from the at least one video file. This is not limited in this embodiment of the present disclosure. In an example, the plurality of frames of sample images may be from ILSVRC 2015, and ILSVRC 2015 is a data set for visual recognition. The computer device may alternatively download a video file from a network to perform image extraction. Because a sample image of the present disclosure does not need to carry tag data and does not need to be manually annotated, obtaining of the plurality of frames of sample images can be very convenient. A manner used is not limited in this embodiment of the present disclosure.

In a possible embodiment, the plurality of frames of sample images may alternatively be cropped images of extracted or obtained images. After extracting or obtaining a plurality of frames of images in the foregoing manner, the computer device may crop the plurality of frames of images, to obtain the plurality of frames of sample images. When performing cropping, the computer device may use a center of the plurality of frames of images as a criterion, and crop a target area with the center as a center point from the plurality of frames of images, to obtain the plurality of frames of sample images.

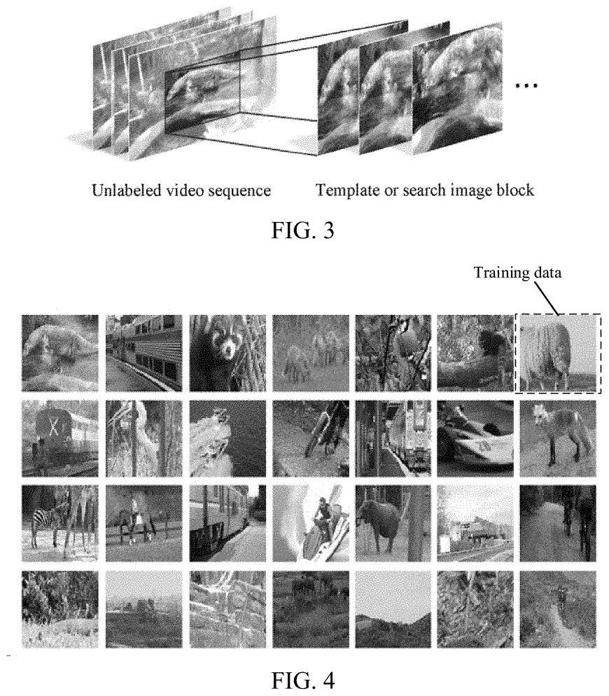

For example, as shown in FIG. 3, the plurality of frames of sample images includes a plurality of sample image sets and each sample image set includes three frames of sample images. The computer device may extract three frames of images from an image sequence of an unlabeled video, and crop central areas (e.g., areas identified by a rectangular box in FIG. 3) of the three frames of images to obtain three frames of sample images. The three frames of sample images may include a template image and a search image block, where the template image refers to a first sample image, and the search image block refers to the search image, that is, the second sample image. FIG. 3 only shows a process of obtaining one sample image set. The computer device may obtain a large number of sample images in the same manner, to train the initial model. The foregoing sample image obtaining process is implemented based on a basic assumption that the selected target does not move out of the specific area (the central area of the image) within the short time (within 10 frames). In an ideal case, there may be a complete selected target in the central area of the image. However, in many cases, the central area may include a partial selected target, or even a target contour, a background object, or the like. FIG. 4 shows some randomly acquired training data. FIG. 4 includes a total of 28 images. Each image is an example of a frame of image acquired for a target. These images used as the training data include selected targets, and the selected target may be a person or a thing. Each image is a piece of training data. For example, an image identified by a dashed box in FIG. 4 is a piece of training data. A selected target in the image may be a sheep, and details of each image are not repeated herein. The selected targets are relatively close to central areas of the images, and it is ensured that the selected targets do not move out of specific areas within a short time. There are related designs in the subsequent image processing for this case, and details are not described herein.

In step 202, the computer device invokes an initial model, and randomly selects a target area in a first sample image in the plurality of frames of sample images as a selected target according to the initial model.

After obtaining the plurality of frames of sample images, the computer device may invoke the initial model, and train the initial model based on the plurality of frames of sample images. A model parameter of the initial model is an initial value. The initial model may process the plurality of frames of sample images based on the model parameter, and predict positions of a target in the plurality of frames of sample images. A predicted result obtained may be inaccurate. Therefore, the computer device may adjust the model parameter of the initial model in the training process, to increase an error value of image processing by the initial model, and a position obtaining model finally obtained through training may process an image with a high error value.

Therefore, the computer device may perform step 202 to input the plurality of frames of sample images into the initial model. Because the plurality of frames of sample images are not manually annotated and the plurality of frames of sample images does not include a given target, the initial model may randomly select a target area from the first sample image as a selected target, further obtain a position of the selected target in the second sample image through prediction, and perform the subsequent training process.

The process of randomly selecting the target area by the computer device may be implemented based on a random algorithm, and the random algorithm may be set by a person skilled in the art according to requirements. This is not limited in this embodiment of the present disclosure.

In step 203, the initial model in the computer device obtains a third position of the selected target in a second sample image based on a first position of the selected target in the first sample image, the first sample image, and the second sample image.

After determining the selected target in the first sample image, the computer device may further obtain a position of the selected target in the second sample image, such as the third position, based on the selected target. As can be understood, the computer device determines the selected target in the first sample image, and the first position of the selected target in the first sample image is a real position. Therefore, the computer device may use the first position as real data to determine an error value of the subsequent prediction data. For details, refer to the following steps 203 to 205. Details are not described in this embodiment of the present disclosure herein.

The initial model in the computer device may process the first sample image and the second sample image based on the first position of the selected target in the first sample image, to obtain the third position, that is, a predicted position, of the selected target in the second sample image. For example, the prediction process may be a forward process, and the computer device may predict the third position of the target in the second sample image based on the first position of the target in the first sample image, to implement the target tracking process. In a possible implementation, the prediction process may be implemented through the following steps 1 and 2:

Step 1. The initial model in the computer device obtains a first image processing parameter based on the first position of the target in the first sample image and the first sample image.

In step 1, the initial model in the computer device may determine the first image processing parameter when data before processing and a processing result are known. The first image processing parameter is used for indicating how to process the first sample image to obtain the first position of the selected target in the first sample image. The first image processing parameter obtained in this way may be used to perform similar processing on the second sample image, thereby obtaining the third position of the selected target in the second sample image.

In a possible implementation, the initial model in the computer device may first extract an image feature of the first sample image, and then process the image feature. In step 1, the initial model in the computer device may perform feature extraction on the first sample image based on the model parameter of the initial model, to obtain an image feature of the first sample image. The initial model in the computer device obtains the first image processing parameter based on the image feature of the first sample image and the first position of the selected target in the first sample image. The initial model in the computer device processes the image feature of the first sample image based on the first image processing parameter, and a result that is to be obtained is the first position of the selected target in the first sample image.

Step 2. The initial model in the computer device processes the second sample image based on the first image processing parameter, to obtain the third position of the selected target in the second sample image.

In step 2, after determining the first image processing parameter, the initial model in the computer device learns how to process the sample image, and thus may perform similar processing on the second sample image, to predict the third position of the selected target in the second sample image.

In step 1, in the implementation that the initial model in the computer device first extracts the image feature of the first sample image and then processes the image feature, the initial model in the computer device may perform feature extraction on the second sample image based on the model parameter of the initial model, to obtain an image feature of the second sample image. The computer device processes the image feature of the second sample image based on the first image processing parameter, to obtain the third position of the selected target in the second sample image.

In a possible embodiment, the first position of the selected target in the first sample image may be indicated in the form of position indication information. Therefore, in step 203, the initial model in the computer device may generate first position indication information corresponding to the first sample image based on the first position of the selected target in the first sample image, where the first position indication information is used for indicating the first position of the selected target in the first sample image. Then the initial model in the computer device may obtain position indication information corresponding to the second sample image based on the first position indication information, the first sample image, and the second sample image, where the position indication information corresponding to the second sample image is used for indicating the third position of the selected target in the second sample image.

Correspondingly, in step 2, when processing the image feature of the second sample image based on the first image processing parameter, the initial model in the computer device may obtain the position indication information corresponding to the second sample image. In a possible embodiment, the initial model may convolve the first image processing parameter and the image feature of the second sample image, to obtain the position indication information corresponding to the second sample image.

In a possible implementation, the first position indication information and the position indication information corresponding to the second sample image may be a response diagram, and a position of a peak of the response diagram is the position of the selected target. For example, the response diagram may be a matrix, and each value in the matrix may be used to represent one or more pixels. In fact, the foregoing process may be: after obtaining the selected target, the initial model in the computer device may generate the first position indication information based on the first sample image and the first position of the selected target in the first sample image, the first position indication information being a real label of the first sample image; and the initial model in the computer device performs feature extraction on the first sample image based on the model parameter, to obtain the image feature of the first sample image. Originally, when the computer device processes the image feature of the first sample image based on the first image processing parameter, the first position indication information (the response diagram or the real label) is to be obtained. Now, the image feature of the first sample image has been processed and the first position indication information is obtained, the first image processing parameter may be calculated. Then feature extraction is performed on the second sample image to obtain the image feature of the second sample image. Based on the calculated first image processing parameter, the image feature of the second sample image is processed to obtain the position indication information corresponding to the second sample image, which is also a response diagram.

In a possible embodiment, the first position indication information may be a Gaussian-shaped response diagram. The position indication information corresponding to the second sample image may be irregular and thus is not a Gaussian-shaped response diagram.

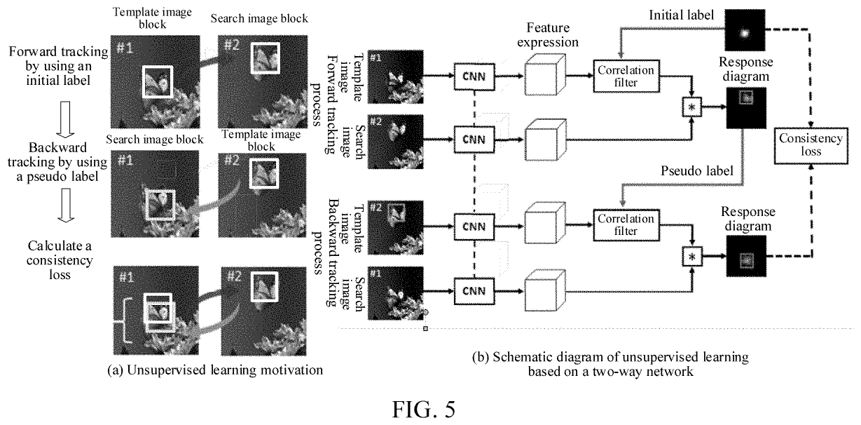

For example, the initial model may include a two-way network, where one path is used to process the first sample image, and the other path is used to process the second sample image. The foregoing first image processing parameter may be a coefficient in a correlation filter, which is used as an example. The process in step 203 may be as shown in (a) and (b) in FIG. 5. An example is used in which the first sample image is a template image or a template image block, the second sample image is a search image or a search image block, an initial label is the first position indication information, and the response diagram is the position indication information corresponding to the second sample image. The initial model may first determine a selected target in the template image, generate the initial label after determining the selected target, perform feature extraction on the template image based on a convolutional neural network (CNN), and perform feature expression, thereby calculating the coefficient in the correlation filter based on the initial label and an image feature of the template image. The initial model may perform feature extraction on the search image, and then convolve the coefficient of the correlation filter and an image feature of the search image, to obtain a response diagram. A position of a peak of the response diagram is the third position of the selected target in the second sample image.

A time sequence of steps in which the initial model performs feature extraction on the template image and the search image is not limited in this embodiment of the present disclosure, and the steps may be performed simultaneously or sequentially. The initial model and the finally obtained position obtaining model are extremely lightweight. For example, only two convolutional layers may be included, and sizes of CNN filters may be 3×3×32×32 and 3×3×32×32. Local response normalization may be further performed on the last layer. This lightweight network structure can achieve extremely high efficiency of tracking a target. In a possible implementation, in an unsupervised model based on forward and backward, general feature expressions may be further learned, and good target tracking may be implemented after the training is completed.

In a possible implementation, the process of obtaining the first image processing parameter by the initial model may be implemented based on the following formula 1:

$${W}_{T} = {ℱ}^{- 1} ( \frac{ℱ ( {φ}_{θ} ( T ) ) ⊙ {ℱ}^{*} ( {Y}_{T} )}{{ℱ}^{*} ( {φ}_{θ} ( T ) ) ⊙ ℱ ( {φ}_{θ} ( T ) ) + λ} ) , , \qquad Formula 1$$

where φθ(⋅) represents a feature extraction operation of a CNN, θ is a model parameter that the network needs to learn, and Y_{T} is the first position indication information of the first sample image, that is, the initial label. W_{T} is the first image processing parameter, that is, the coefficient of the correlation filter in the example, λ is a regularization parameter, ⊙ is a dot product operation between elements, [symbol] (⋅) is a discrete Fourier transform, [symbol] ⁻¹ (⋅) is an inverse discrete Fourier transform, and * represents a complex conjugate. The calculation process is performed in the Fourier domain. T is used to identify the first sample image.

After obtaining the first image processing parameter W_{T}, the initial model may process the second sample image, and the processing process may be implemented based on the following formula 2:

R_{S}= [symbol] ⁻¹ ( [symbol] *(W_{T}) └ [symbol] (φθ(S)))., Formula 2
where R_{S} is the position indication information corresponding to the second sample image, that is, the response diagram corresponding to the second sample image in the foregoing example, W_{T} is the first image processing parameter, that is, the coefficient of the correlation filter in the example, [symbol] (⋅) is a discrete Fourier transform, [symbol] ⁻¹ (⋅) is an inverse discrete Fourier transform, * represents a complex conjugate, and ⊙ is a dot product operation between elements. T is used to identify the first sample image, and S is used to identify the second sample image. φθ(⋅) represents a feature extraction operation of the CNN.

In step 204, the initial model in the computer device obtains a second position of the selected target in the first sample image based on the third position of the selected target in the second sample image, the first sample image, and the second sample image, the second sample image being a sample image different from the first sample image in the plurality of frames of sample images.

In the foregoing step, based on the first position of the selected target in the first sample image, the computer device obtains the third position of the selected target in the second sample image through a forward process, and then may use the third position of the selected target in the second sample image as a pseudo label of the second sample image, that is, the third position of the selected target in the second sample image is not real data, but may be assumed as real data to perform a backward process to obtain the second position of the selected target in the first sample image. The backward process is the same as the image processing process of the forward process, except that the first sample image and the second sample image are interchanged: the second sample image is used as the template image, and the first sample image is used as the search image, to perform backward prediction.

Similar to the content shown in the foregoing step 203, step 204 may also be implemented through the following steps 1 and 2:

Step 1. The initial model in the computer device obtains a second image processing parameter based on the third position of the selected target in the second sample image and the second sample image.

This step is the same as step 1 in step 203, except that the first sample image and the second sample image are interchanged: the second sample image is used as the template image, and the first sample image is used as the search image, to perform the same processing process. The second image processing parameter is used for indicating how to process the second sample image to obtain the second position of the selected target in the second sample image.

Similar to step 1 in step 203, the initial model in the computer device may also first extract an image feature, and then process the image feature. For example, the initial model in the computer device may perform feature extraction on the second sample image based on the model parameter of the initial model, to obtain an image feature of the second sample image. The initial model in the computer device obtains the second image processing parameter based on the image feature of the second sample image and the third position of the selected target in the second sample image.

Step 2. The initial model in the computer device processes the first sample image based on the second image processing parameter, to obtain the second position of the selected target in the first sample image.

This step is the same as step 2 in step 203, except that the first sample image and the second sample image are interchanged: the second sample image is used as the template image, and the first sample image is used as the search image, to perform the same processing process.

Similar to step 1 in step 203, the initial model in the computer device may also perform feature extraction on the first sample image based on the model parameter of the initial model, to obtain an image feature of the first sample image. The computer device processes the image feature of the first sample image based on the second image processing parameter, to obtain the second position of the selected target in the first sample image.

In an implementation shown in step 203, the position of the selected target in the image may be indicated by position indication information. In step 204, the initial model in the computer device may alternatively obtain second position indication information corresponding to the first sample image based on the position indication information corresponding to the second sample image, the first sample image, and the second sample image, the second position indication information being used for indicating the second position of the selected target in the first sample image.

For example, when the foregoing manner of first extracting and then processing the image feature and the manner of using the position indication information are used simultaneously, step 204 may be as follows: the initial model in the computer device performs feature extraction on the second sample image based on the model parameter to obtain the image feature of the second sample image, obtains the second image processing parameter based on the image feature and the position indication information (the third position of the selected target in the second sample image) corresponding to the second sample image, performs feature extraction on the first sample image to obtain the image feature of the first sample image, and processes the image feature of the first sample image based on the second image processing parameter, to obtain the second position indication information (the second position of the selected target in the first sample image) corresponding to the first sample image.

Step 203 is the forward process, and step 204 is the backward process. Through the forward plus backward processes, based on the first position (real position) of the selected target in the first sample image, the second position (predicted position) of the selected target in the first sample image may be obtained through transition of the second sample image, so that an error value of image processing by the initial model may be obtained based on the first position and the second position. For example, as shown in (b) in FIG. 5, step 203 corresponds to a forward tracking process, and step 204 corresponds to a backward tracking process. In the backward tracking process, the template image and the search image are interchanged, that is, the template image becomes the second sample image, and the search image becomes the first sample image. However, the processing of the template image and the search image is the same as the forward tracking process. A response diagram obtained in the backward tracking process is the second position indication information corresponding to the first sample image. As shown in FIG. 5(a), #1 in FIG. 5 is used to identify the first sample image, and #2 is used to identify the second sample image. It may be obtained from FIG. 5 that, for the selected target determined in #1 (a position identified by a white rectangle in #1 used as the template image block in FIG. 5(a)), the predicted position, that is, the third position, of the selected target may be determined in #2 (a position identified by a white rectangle in #2 used as the search image block in FIG. 5(a)). Then, based on the third position of the selected target in #2, the second position of the selected target in #1 is tracked backward (a position identified by a gray rectangle in #1 used as the search image block in FIG. 5(a)), and then based on the first position of the target in #1 (the position identified by the white rectangular box) and the second position (the position identified by the gray rectangular box), it is determined whether the error value of the initial model is good. That is, consistency calculation is performed on the first position of the selected target determined in #1 and the second position obtained through backward calculation of #2.

In a possible implementation, the initial model in the computer device may alternatively perform step 204 by using formulas the same as the foregoing formula 1 and formula 2, that is, T in formula 1 is replaced with S, Y_{T} is replaced with Y_{S}. Y_{S} is R_{S} or a Gaussian-shape response diagram generated based on R_{S}, S in Formula 2 is replaced with T, and W_{T} is replaced with W_{S}, where Y_{S} is the position indication information corresponding to the second sample image or Gaussian-shaped position indication information obtained based on R_{S}. In the forward and backward tracking processes, the model parameter of the CNN is fixed.

In step 205, the computer device obtains an error value of the second position relative to the first position based on the first position and the second position of the selected target in the first sample image.

After obtaining the first position and the second position of the selected target in the first sample image, the computer device may evaluate the prediction error value of the initial model, to determine, based on the error value of the second position relative to the first position of the target in the first sample image, whether to adjust the model parameter of the initial model need to be adjusted. In a possible implementation, a smaller error value indicates a more appropriate model parameter of the initial model. In another possible implementation, the process may be alternatively implemented by using a reward mechanism, and a greater error value indicates a more appropriate model parameter of the initial model. A description is made by using an example in which a smaller error value indicates a more appropriate model parameter. Based on this principle, the following step 206 may be performed to train the initial model, to obtain a position obtaining model with a small prediction error value.

In a possible implementation, the plurality of frames of sample images may include a plurality of sample image sets, and each sample image set corresponds to one error value at the predicted position. The computer device may obtain at least one error value based on a first sample image and at least one frame of second sample image included in the sample image set, that is, each frame of second sample image may correspond to an error value, and an error value corresponding to the sample image set may be determined based on the at least one error value.

In a possible implementation, the computer device may obtain an average value of the at least one error value, and use the average value as the error value corresponding to the sample image set. In a possible implementation, the computer device may perform weighted summation on the at least one error value, to obtain the error value corresponding to the sample image set. An implementation is not limited in this embodiment of the present disclosure.

In step 206, the computer device adjusts a model parameter of the initial model based on the error value until a target condition is met, to obtain a position obtaining model.

After obtaining the error value predicted by using the initial model, the computer device may adjust the model parameter based on the error value until the error value is relatively small, to obtain the position obtaining model. The prediction accuracy of the position obtaining model is relatively high. The target condition may be that the error value converges or a quantity of iterations reaches a target quantity. The position obtaining model obtained by using the target condition has good image processing capabilities, and can achieve a target tracking process with a small error value.

In a possible implementation, the plurality of frames of sample images may include a plurality of sample image sets, and each sample image set corresponds to one error value at the predicted position. The computer device may adjust the model parameter of the initial model according to an error value corresponding to each sample image set.

In another possible implementation, the computer device may further divide training samples into a plurality of batches, and each batch includes a target quantity of sample image sets. The computer device may adjust the model parameter of the initial model based on error values corresponding to each batch. For example, for each target quantity of sample image sets in the plurality of sample image sets, the computer device may adjust the model parameter of the initial model based on a plurality of error values corresponding to the target quantity of sample image sets. The target quantity may be preset by a person skilled in the art according to requirements, which is not limited in this embodiment of the present disclosure.

In a possible embodiment, when the computer device adjusts the model parameter of the initial model, the plurality of sample image sets may further include undesirable sample images. For example, in a plurality of frames of sample images in a sample image set, a movement displacement of the selected target is excessively large, and the selected target may even move out of a coverage of the image; an error value corresponding to such a sample image set does not play an important role in the training of the initial model. The impact of such samples is to be weakened, and such samples may be referred to as difficult samples. In this case, the computer device may further perform any of the following manners:

Manner 1: the computer device removes error values meeting an error value condition in the plurality of error values based on the plurality of error values corresponding to the target quantity of sample image sets, and adjusts the model parameter of the initial model based on the plurality of remaining error values.

Manner 2: the computer device determines first weights of the plurality of error values based on the plurality of error values corresponding to the target quantity of sample image sets, and adjusts the model parameter of the initial model based on the first weights of the plurality of error values and the plurality of error values, first weights of the error values meeting the error value condition in the plurality of error values being zero.

The manner 1 and manner 2 are both processes of reducing an effect of the error values meeting the error value condition in the plurality of error values on the adjustment of the model parameter to zero. In manner 1, the error values are directly removed, and in manner 2, the first weights are set for the error values, and the weights are set to zero. The error value condition may be an error value belonging to a target proportion with a largest error value. Both the error value condition and the target portion may be preset by a person skilled in the art according to requirements, which is not limited in this embodiment of the present disclosure. For example, the target proportion may be 10%. The computer device may remove 10% of training samples in a batch, that is, remove the 10% with largest error values, or reset weights of the error values of the 10% with the largest error values to zero. For example, in manner 2, a binary weight A_{drop} (a first weight) is introduced, the weight A_{drop} of the error values meeting the error value condition is 0, and a weight of other error values is 1. Therefore, an impact of noise samples and even polluted samples (with an occlusion problem) is reduced, and the convergence of model training is not affected due to such training samples.

In a possible embodiment, each sample image set may correspond to a second weight, and the second weight is used for indicating a displacement of a selected target in a plurality of frames of sample images of the sample image set. As can be understood, when a movement displacement of the selected target in the plurality of frames of sample images in the sample image set is very small, or even zero, the selected target is tracked, and an error value obtained does not reflect a prediction capability of the initial model. Therefore, an effect of the error value in adjusting the model parameter is to be weakened.

In this embodiment, in step 206, the computer device may obtain a second weight of an error value of each sample image set, the second weight being positively correlated with a displacement of the target in the plurality of frames of sample images in the each sample image set. After obtaining the second weight, the computer device may adjust the model parameter of the initial model based on the plurality of error values and a plurality of second weights corresponding to the target quantity of sample image sets. For example, the computer device may obtain a total error value corresponding to the target quantity of sample image sets based on the plurality of error values and the plurality of second weights corresponding to the target quantity of sample image sets, to adjust the model parameter of the initial model based on the total error value.

For example, in a specific example, a second weight Aₘₒₜᵢₒₙ may be introduced, and the computer device may obtain the second weight by using the following formula 3:

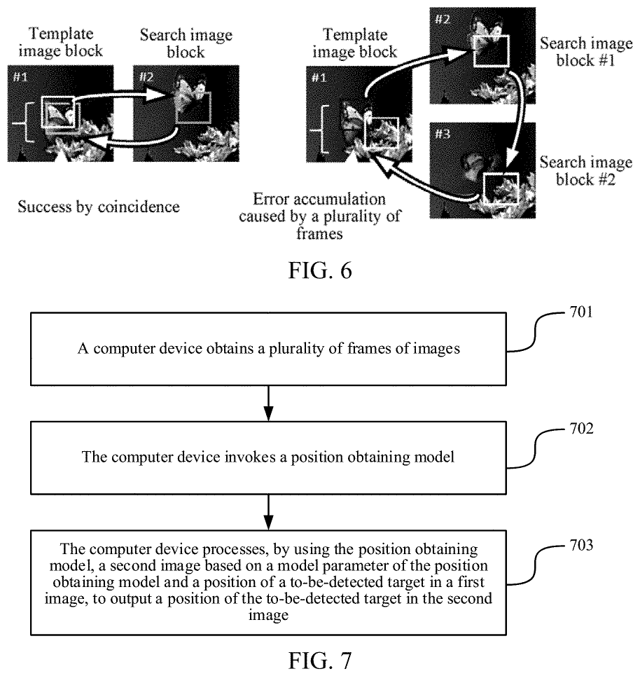

Aₘₒₜᵢₒₙⁱ =∥R_{S}_{₁}ⁱ−Y_{T}ⁱ∥₂²+∥R_{S}_{₂}ⁱ−Y_{S}_{₁}ⁱ∥₂², Formula 3
where Aₘₒₜᵢₒₙ is the second weight, i is an identifier of the sample image set, R_{S} is the position indication information corresponding to the second sample image, Y_{T} is the first position indication information corresponding to the first sample image, Y_{S} is the position indication information corresponding to the second sample image or the Gaussian-shape position indication information obtained based on R_{S}. In this formula, for example, the sample image set includes only one frame of first sample image and two frames of second sample images. T is used to represent the first sample image, S is used to represent the second sample image, S1 is used to represent one frame of second sample image, and S2 is used to represent the other frame of second sample image. For example, as shown in FIG. 6, a case of using one frame of first sample image (template image block) and one frame of second sample image (search image block) is shown in #1 and #2 in the left figure, which may be a success by coincidence. A case of using one frame of first sample image and two frames of second sample images is shown in #1, #2, and #3 in the right figure. #2 in the right figure may be also referred to as a search image block #1, and #3 in the right figure may be also referred to as a search image block #2. By adding a second sample image, the success by coincidence can be avoided, and errors may be accumulated, thereby improving accuracy and stability of the position obtaining model.

In a possible implementation, the computer device may integrate the foregoing first weight and second weight to adjust the model parameter, that is, both an excessive sample error value and the displacement are taken into account. For example, for the plurality of error values corresponding to the target quantity of sample image sets, the computer device may obtain a total weight of the error values based on the first weight and the second weight, perform weighted summation on the plurality of error values based on the total weight of the plurality of error values, to obtain a total error value of the plurality of error values, and adjust the model parameter of the initial model based on the total error value.

For example, the process of obtaining the total error value may be implemented by using the following formula 4:

$${A}_{norm}^{i} = \frac{{A}_{drop}^{i} \cdot {A}_{motion}^{i}}{{\sum }_{i = 1}^{n} {A}_{drop}^{i} \cdot {A}_{motion}^{I}} , , \qquad Formula 4$$

where A_{drop} is the first weight, Aₘₒₜᵢₒₙ is the second weight, n is the target quantity and is a positive integer greater than 1, and i is the identifier of the sample image set. Aₙₒᵣₘⁱ is the total weight.

The total error value may be represented by a reduced reconstruction error. For example, the process of obtaining the total error value may be implemented by using the following formula 5:

$${ℒ}_{un} = \frac{1}{n} {\sum }_{i = 1}^{n} {A}_{norm}^{i} \cdot {‖ {\tilde{R}}_{T}^{i} - {Y}_{T}^{i} ‖}_{2}^{2} . , \qquad Formula 5$$

where R_{T} is the second position (the second position indication information corresponding to the first sample image) of the selected target in the first sample image, Y_{T} is the first position (the first position indication information corresponding to the first sample image) of the selected target in a sample image, n is the target quantity and is a positive integer greater than 1, and i is the identifier of the sample image set. [symbol] ᵤₙ is the total error value corresponding to the target quantity of sample image sets. This is only an exemplary description, and the total error value may be alternatively represented by another error or reward value, which is not limited in this embodiment of the present disclosure.

By obtaining the total weight, a case of excessively small displacement of the target in the plurality of frames of images is optimized, and a case of excessively large displacement of the selected target in the plurality of frames of sample images is also optimized. Therefore, a relatively small total error value may be obtained. Based on this, when the model parameter is adjusted, the accuracy of image processing of the obtained position obtaining model is also improved.

If the sample image set includes only one frame of first sample image and one frame of second sample image, the process of obtaining the total error value may be implemented by using the following formula 6:

[symbol]

ᵤₙ=∥\tilde{R}_{T}−Y_{T}∥₂², Formula 6:
where \tilde{R}_{T} is the second position (the second position indication information corresponding to the first sample image) of the selected target in the first sample image, Y_{T} is the first position (the first position indication information corresponding to the first sample image) of the selected target in a sample image, and [symbol] ᵤₙ is the total error value corresponding to the target quantity of sample image sets.

In a possible implementation, the model parameter adjustment process may be implemented by gradient backhaul. For details, refer to the following formula 7, which is only used as an exemplary description and does not limit the adjustment process:

$$\frac{\partial {ℒ}_{un}}{\partial {φ}_{θ} ( T )} = {ℱ}^{- 1} ( \frac{\partial {ℒ}_{un}}{\partial {( ℱ ( {φ}_{θ} ( T ) ) )}^{*}} + {( \frac{\partial {ℒ}_{un}}{\partial ( ℱ ( {φ}_{θ} ( T ) ) )} )}^{*} ) \cdot \frac{\partial {ℒ}_{un}}{\partial {φ}_{θ} ( S )} = {ℱ}^{- 1} ( \frac{\partial {ℒ}_{un}}{\partial {( ℱ ( {φ}_{θ} ( S ) ) )}^{*}} ) \cdot , \qquad Formula 7$$

where ∂ is a partial differential symbol, [symbol] ᵤₙ is the total error value corresponding to the target quantity of sample image sets, [symbol] (⋅) is a discrete Fourier transform, [symbol] ⁻¹ (⋅) is an inverse discrete Fourier transform, and represents a complex conjugate. T is used to identify the first sample image, and S is used to identify the second sample image. φθ(⋅) represents a feature extraction operation of the CNN.

In an example, the position obtaining model may be referred to as a tracker. The tracker may perform forward and backward tracking, that is, given an initial tracking target, the tracker may track the target forward, and meanwhile, the tracker is able to trace back to an initially specified position by using a tracking end position as a start point. Through self-calibration of the tracker, unsupervised training may be carried out. A robust tracker may be trained without requiring sample images to carry labels, and can have similar performance to a fully-supervised training tracker.

In the embodiments of the present disclosure, the plurality of frames of images are processed by using the position obtaining model obtained through training, to obtain the positions of the target in the plurality of frames of images. The position obtaining model may be obtained through training in forward and backward processes. Through the forward process, the third position of the selected target in the second sample image may be predicted according to the first position of the selected target in the first sample image; and through the backward process, the second position of the selected target in the first sample image may be predicted according to the third position. Because the selected target is randomly selected from the first sample image, and the selected position is determined, the first position is a real position of the selected target. Based on the first position and the second position of the selected target in the first sample image, the accuracy of the model parameter of the initial model may be reflected by an error value between the first position and the second position. Therefore, the initial model may be trained according to the first position and the second position without manual annotation by a person skilled in the art, which can effectively reduce labor costs and improve efficiency of model training. The image processing process is simple, effectively improving efficiency of the entire process of obtaining a position of a target.

The process of training the position obtaining model is described in detail in the embodiment shown in FIG. 2. A process of applying the position obtaining model to implement obtaining of a position of a target is described by using an embodiment shown in FIG. 7 below. FIG. 7 is a flowchart of a method for obtaining a position of a target according to an embodiment of the present disclosure. The method for obtaining a position of a target may be applied to a computer device, and the computer device may be provided as a terminal, or may be provided as a server. This is not limited in this embodiment of the present disclosure. Referring to FIG. 7, the method may include the following steps.

In step 701, a computer device obtains a plurality of frames of images, a first image in the plurality of frames of images including a to-be-detected target, the first image being any frame of image in the plurality of frames of images.

The computer device may obtain a plurality of frames of images, and process the plurality of frames of images to determine first positions of a to-be-detected target in the plurality of frames of images.

In step 701, the computer device may obtain the plurality of frames of images in many manners. In different application scenarios, the computer device may obtain the plurality of frames of images in different manners. For example, the computer device may be provided with an image obtaining function. The computer device may capture images, and perform the following image processing process on a plurality of frames of images captured, to track a to-be-detected target in the plurality of frames of images. The computer device may alternatively receive a plurality of frames of images sent by an image obtaining device, and perform the following image processing process, to track a to-be-detected target in the plurality of frames of images. The computer device may further obtain a video shot in real time or a video stored at a target address, extract a plurality of frames of images from the video, and perform the following image processing process, to track a to-be-detected target in the plurality of frames of images. The application scenario and the manner in which the computer device obtains a plurality of frames of images are not limited in this embodiment of the present disclosure.

In a possible implementation, similar to the foregoing step 201, the computer device may alternatively crop the obtained or extracted plurality of frames of images to obtain a plurality of frames of images to be processed. For example, the computer device may crop, from the obtained or extracted plurality of frames of images, a target area with a center of the plurality of frames of images as a center point, to obtain the plurality of frames of images to be processed. Details are not described in this embodiment of the present disclosure.

In step 702, the computer device invokes a position obtaining model.

A model parameter of the position obtaining model is obtained through training based on a position (real position) of the to-be-detected target in a first sample image in the plurality of frames of sample images and a position (predicted position) of the to-be-detected target in the first sample image. The position of the to-be-detected target in the first sample image is obtained based on a position of the to-be-detected target in a second sample image in the plurality of frames of sample images. The position obtaining model may be obtained through training based on the model training process shown in FIG. 2.

The computer device shown in FIG. 7 may be the foregoing computer device shown in FIG. 2, that is, the computer device may invoke the position obtaining model from locally stored data. The computer device shown in FIG. 7 and the computer device shown in FIG. 2 may be alternatively different computer devices. The computer device shown in FIG. 2 may encapsulate and send the position obtaining model obtained through training to the computer device shown in FIG. 7, and the computer device shown in FIG. 7 performs processing such as decompression on the position obtaining model. When image processing is needed, the position obtaining model may be invoked. When image processing is needed, the computer device shown in FIG. 7 may further invoke the trained position obtaining model in the computer device shown in FIG. 2 in real time, which is not limited in this embodiment of the present disclosure.

In step 703, the computer device obtains, by using the position obtaining model, a second image based on a model parameter of the position obtaining model and a position of a to-be-detected target in a first image, to output a position of the to-be-detected target in the second image, the second image being another image different from the first image in the plurality of frames of images.

The position of the to-be-detected target in the first image may be obtained by manual annotation by a person skilled in the art, or may be obtained by scanning the first image based on a scan setting by the computer device. For example, a person skilled in the art may annotate a target area in the first image according to requirements, and use the target area as the to-be-detected target. In another example, the computer device may be set to track a person. Therefore, the computer device may perform scanning and face recognition on the first image, to determine a position of the person and use the position as a to-be-detected target. Two examples are provided herein. The method for obtaining the position of the to-be-detected target may be further applied to another application scenario. The computer device may alternatively use another method to determine the position of the to-be-detected target in the first image. This is not limited in this embodiment of the present disclosure.

Step 703 is similar to the foregoing step 203. The computer device may obtain the position of the to-be-detected target in the second image through the following steps 1 and 2.

Step 1. The position obtaining model in the computer device obtains an image processing parameter based on the position of the to-be-detected target in the first image, the first image, and the model parameter.

Similar to step 1 in the foregoing step 203, the position obtaining model in the computer device may generate position indication information corresponding to the first image based on the position of the to-be-detected target in the first image, the position indication information corresponding to the first image being used for indicating the position of the target in the first image. The position obtaining model in the computer device may obtain the image processing parameter based on the position indication information corresponding to the first image, the first image, and the model parameter.

In a possible implementation, the position indication information is a response diagram, and a position of a peak of the response diagram is the position of the to-be-detected target.

Similarly, in a possible embodiment, the position obtaining model in the computer device may perform feature extraction on the first image based on the model parameter, to obtain an image feature of the first image, and obtain the image processing parameter based on the image feature of the first image and the position indication information corresponding to the first image.

Step 2. The position obtaining model in the computer device processes the second image based on the image processing parameter, to output the position of the to-be-detected target in the second image.

Similar to step 2 in the foregoing step 203, the position obtaining model in the computer device may process the second image based on the image processing parameter to output the position indication information corresponding to the second image, the position indication information corresponding to the second image being used for indicating the position of the to-be-detected target in the second image.

Similar to step 2 in step 203, the position obtaining model in the computer device may perform feature extraction on the second image based on the model parameter, to obtain an image feature of the second image, and process the image feature of the second image based on the image processing parameter, to output the position indication information corresponding to the second image.

Step 703 is similar to the foregoing step 203. Details are not described herein.

In the embodiments of the present disclosure, the plurality of frames of images are processed by using the position obtaining model obtained through training, to obtain the positions of the to-be-detected target in the plurality of frames of images. The position obtaining model may be obtained by training the initial model by using the real position and the predicted position of the to-be-detected target in the first sample image through the forward and backward processes without manual annotation by a person skilled in the art, which can effectively reduce labor costs and improve efficiency of model training. The image processing process is simple, effectively improving efficiency of the entire process of obtaining the position of the to-be-detected target.

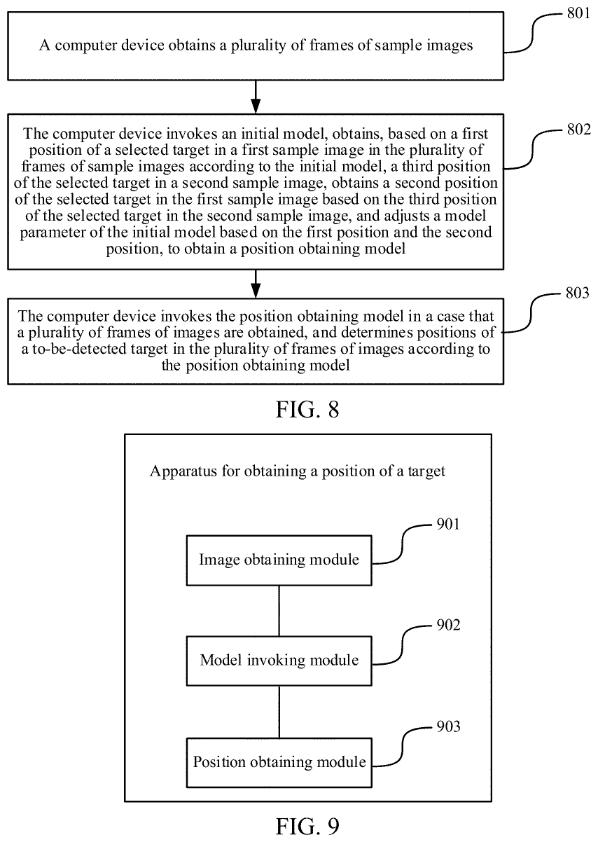

The following describes a model training process and a model use process by using an embodiment shown in FIG. 8. FIG. 8 is a flowchart of a method for obtaining a position of a target according to an embodiment of the present disclosure. Referring to FIG. 8, the method may include the following steps.

In step 801, a computer device obtains a plurality of frames of sample images.

In step 802, the computer device invokes an initial model, obtains, based on a first position of a selected target in a first sample image in the plurality of frames of sample images according to the initial model, a third position of the selected target in a second sample image, obtains a second position of the selected target in the first sample image based on the third position of the selected target in the second sample image, and adjusts a model parameter of the initial model based on the first position and the second position, to obtain a position obtaining model, the selected target being obtained by randomly selecting a target area in the first sample image by the initial model, the second sample image being a sample image different from the first sample image in the plurality of frames of sample images.

Steps 801 and 802 have the same content as the embodiment shown in FIG. 2, and details are not described in this embodiment of the present disclosure herein.

In step 803, the computer device invokes the position obtaining model when a plurality of frames of images are obtained, and determines positions of a to-be-detected target in the plurality of frames of images according to the position obtaining model.

Step 803 has the same content as the embodiment shown in FIG. 7, and details are not described in this embodiment of the present disclosure herein.

In the embodiments of the present disclosure, the selected target in the first sample image is randomly selected by using the initial model, and transition is performed based on the second sample image. Through the forward and backward processes, the predicted position of the selected target in the first sample image is obtained. The initial model is trained by using the real position and the predicted position of the target in the first sample image without manual annotation by a person skilled in the art, which can effectively reduce labor costs and improve efficiency of model training. In addition, the image may be processed by the position obtaining model trained in this way, to obtain the position of the to-be-detected target. The image processing process is simple, effectively improving efficiency of the entire process of obtaining the position of the to-be-detected target.

Additional embodiments of the present disclosure may be formed by using any combination of all the foregoing optional technical solutions, and details are not described herein.

FIG. 9 is a schematic structural diagram of an apparatus for obtaining a position of a target according to an embodiment of the present disclosure. Referring to FIG. 9, the apparatus may include an image obtaining module 901, a model invoking module 902, and a position obtaining module 903. One or more of modules, submodules, and/or units of the apparatus can be implemented by processing circuitry, software, or a combination thereof, for example.

The image obtaining module 901 is configured to obtain a plurality of frames of images, a first image in the plurality of frames of images including a to-be-detected target, the first image being any frame of image in the plurality of frames of images.

The model invoking module 902 is configured to invoke a position obtaining model, a model parameter of the position obtaining model being obtained through training based on a first position of a selected target in a first sample image in a plurality of frames of sample images and a second position of the selected target in the first sample image, the second position being predicted based on a third position of the selected target in a second sample image in the plurality of frames of sample images, the third position being predicted based on the first position, the selected target being randomly selected from the first sample image, the second sample image being a sample image different from the first sample image in the plurality of frames of sample images.

The position obtaining module 903 is configured to determine a position of the to-be-detected target in a second image based on the model parameter and a position of the to-be-detected target in the first image by using the position obtaining model, the second image being an image different from the first image in the plurality of frames of images.

In a possible implementation, the position obtaining module 903 is configured to: obtain an image processing parameter based on the position of the to-be-detected target in the first image, the first image, and the model parameter; and process the second image based on the image processing parameter, to output the position of the to-be-detected target in the second image.
In a possible implementation, the position obtaining module 903 is configured to: generate position indication information corresponding to the first image based on the position of the to-be-detected target in the first image, the position indication information corresponding to the first image being used for indicating a selected position of the to-be-detected target in the first image; obtain the image processing parameter based on the position indication information corresponding to the first image, the first image, and the model parameter; and process the second image based on the image processing parameter, to output position indication information corresponding to the second image, the position indication information corresponding to the second image being used for indicating a predicted position of the to-be-detected target in the second image.
In a possible implementation, the position obtaining module 903 is configured to: perform feature extraction on the first image based on the model parameter, to obtain an image feature of the first image; obtain the image processing parameter based on the image feature of the first image and the position indication information corresponding to the first image; perform feature extraction on the second image based on the model parameter, to obtain an image feature of the second image; and process the image feature of the second image based on the image processing parameter, to output the position indication information corresponding to the second image.

In a possible implementation, the apparatus further includes a model training module. The model training module is configured to obtain a plurality of frames of sample images. The model training module is configured to invoke an initial model, randomly select, by using the initial model, a target area in the first sample image in the plurality of frames of sample images as the selected target, obtain the third position of the selected target in the second sample image based on the first position of the selected target in the first sample image, the first sample image, and the second sample image, and obtain the second position of the selected target in the first sample image based on the third position of the selected target in the second sample image, the first sample image, and the second sample image. The model training module is configured to obtain an error value of the second position relative to the first position based on the first position and the second position of the selected target in the first sample image. Further, the model training module is configured to adjust a model parameter of the initial model based on the error value until a target condition is met, to obtain the position obtaining model.

In a possible implementation, the model training module is configured to obtain a first image processing parameter based on the first position and the first sample image. The model training module is configured to process the second sample image based on the first image processing parameter, to obtain the third position. The model training module is configured to obtain a second image processing parameter based on the third position and the second sample image; and process the first sample image based on the second image processing parameter, to obtain the second position. The model training module is configured to perform feature extraction on the first sample image based on the model parameter of the initial model, to obtain an image feature of the first sample image; and obtain the first image processing parameter based on the image feature of the first sample image and the first position. Further, the model training module is configured to perform feature extraction on the second sample image based on the model parameter of the initial model, to obtain an image feature of the second sample image; and process the image feature of the second sample image based on the first image processing parameter, to obtain the third position.

In a possible implementation, the model training module is configured to generate first position indication information corresponding to the first sample image based on the first position, the first position indication information being used for indicating a selected position of the selected target in the first sample image; and obtain position indication information corresponding to the second sample image based on the first position indication information, the first sample image, and the second sample image, the position indication information corresponding to the second sample image being used for indicating a predicted position of the selected target in the second sample image. The model training module is configured to obtain second position indication information corresponding to the first sample image based on the position indication information corresponding to the second sample image, the first sample image, and the second sample image, the second position indication information being used for indicating a predicted position of the selected target in the first sample image.

In a possible implementation, the plurality of frames of sample images include a plurality of sample image sets, each sample image set includes one frame of first sample image and at least one frame of second sample image, and each sample image set corresponds to one error value at the predicted position. The model training module is configured to adjust, for each target quantity of sample image sets in the plurality of sample image sets, the model parameter of the initial model based on a plurality of error values corresponding to the target quantity of sample image sets.

In a possible implementation, the model training module is configured to perform any one of the following: removing error values meeting an error value condition in the plurality of error values based on the plurality of error values corresponding to the target quantity of sample image sets; and adjusting the model parameter of the initial model based on the remaining error values; or determining first weights of the plurality of error values based on the plurality of error values corresponding to the target quantity of sample image sets; and adjusting the model parameter of the initial model based on the first weights of the plurality of error values and the plurality of error values, first weights of error values meeting an error value condition in the plurality of error values being zero.

In a possible implementation, each sample image set corresponds to a second weight. Further, the adjusting the model parameter of the initial model based on a plurality of error values corresponding to the target quantity of sample image sets includes: obtaining a second weight of an error value of each sample image set, the second weight being positively correlated with a displacement of the selected target in the plurality of frames of sample images in the each sample image set; and adjusting the model parameter of the initial model based on the plurality of error values and a plurality of second weights corresponding to the target quantity of sample image sets.

According to the apparatus provided in the embodiments of the present disclosure, the plurality of frames of images are processed by using the position obtaining model obtained through training, to obtain the positions of the target in the plurality of frames of images. The position obtaining model may be obtained through training in forward and backward processes. Through the forward process, the third position of the selected target in the second sample image may be predicted according to the first position of the selected target in the first sample image; and through the backward process, the second position of the selected target in the first sample image may be predicted according to the third position. Because the selected target is randomly selected from the first sample image, and the selected position is determined, the first position is a real position of the selected target. Based on the first position and the second position of the selected target in the first sample image, the accuracy of the model parameter of the initial model may be reflected by an error value between the first position and the second position. Therefore, the initial model may be trained according to the first position and the second position without manual annotation by a person skilled in the art, which can effectively reduce labor costs and improve efficiency of model training. The image processing process is simple, effectively improving efficiency of the entire process of obtaining a position of a target.

When the apparatus for obtaining a position of a target provided in the foregoing embodiment obtains the position of the target, descriptions are made with an example of division of the foregoing functional modules. In actual application, the functions may be allocated to and completed by different functional modules according to requirements, that is, the internal structure of the computer device is divided into different functional modules, to implement all or some of the functions described above. In addition, the apparatus for obtaining a position of a target provided in the foregoing embodiment and the embodiments of the method for obtaining a position of a target belong to the same concept. For an exemplary implementation process of the apparatus, refer to the method embodiments, and details are not repeated herein.

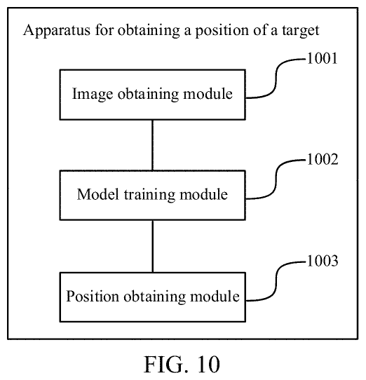

FIG. 10 is a schematic structural diagram of an apparatus for obtaining a position of a target according to an embodiment of the present disclosure. Referring to FIG. 10, the apparatus may include an image obtaining module 1001, a model training module 1002, and a position obtaining module 1003. One or more of modules, submodules, and/or units of the apparatus can be implemented by processing circuitry, software, or a combination thereof, for example.

The image obtaining module 1001 is configured to obtain a plurality of frames of sample images.

The model training module 1002 is configured to invoke an initial model, obtain, based on a first position of a selected target in a first sample image in the plurality of frames of sample images according to the initial model, a third position of the selected target in a second sample image, obtain a second position of the selected target in the first sample image based on the third position of the selected target in the second sample image, and adjust a model parameter of the initial model based on the first position and the second position, to obtain a position obtaining model.

The position obtaining module 1003 is configured to invoke the position obtaining model when a plurality of frames of images are obtained, and determine positions of a to-be-detected target in the plurality of frames of images according to the position obtaining model.

According to the apparatus provided in the embodiments of the present disclosure, the selected target in the first sample image is randomly selected by using the initial model, transition is performed based on the second sample image, and the initial model is trained through the forward and backward processes. Through the forward process, the third position of the selected target in the second sample image may be predicted according to the first position of the selected target in the first sample image; and through the backward process, the second position of the selected target in the first sample image may be predicted according to the third position. Because the selected target is randomly selected from the first sample image, and the selected position is determined, the first position is a real position of the selected target. Based on the first position and the second position of the selected target in the first sample image, the accuracy of the model parameter of the initial model may be reflected by an error value between the first position and the second position. Therefore, the initial model may be trained according to the first position and the second position without manual annotation by a person skilled in the art, which can effectively reduce labor costs and improve efficiency of model training. The image processing process is simple, effectively improving efficiency of the entire process of obtaining a position of a target.

When the apparatus for obtaining a position of a target provided in the foregoing embodiment obtains the position of the target, descriptions are made with an example of division of the foregoing functional modules. In actual application, the functions may be allocated to and completed by different functional modules according to requirements, that is, the internal structure of the computer device is divided into different functional modules, to implement all or some of the functions described above. In addition, the apparatus for obtaining a position of a target provided in the foregoing embodiment and the embodiments of the method for obtaining a position of a target belong to the same concept. For an exemplary implementation process of the apparatus, refer to the method embodiments, and details are not repeated herein.

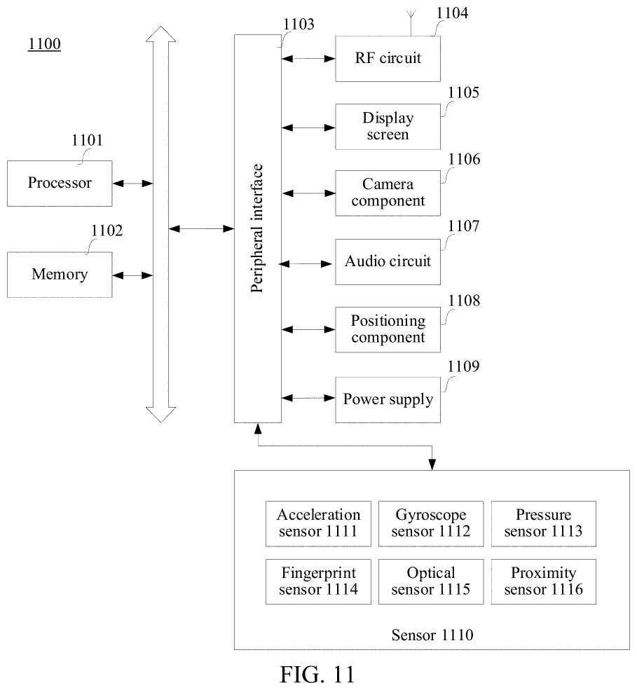

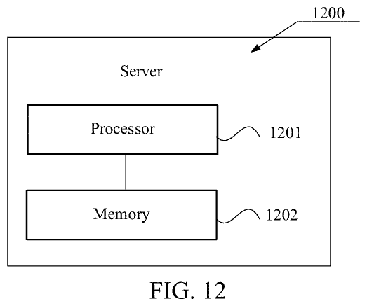

The computer device may be provided as a terminal shown in FIG. 11, or may be provided as a server shown in FIG. 12. This is not limited in this embodiment of the present disclosure.

FIG. 11 is a schematic structural diagram of a terminal according to an embodiment of the present disclosure. The terminal 1100 may be a smartphone, a tablet computer, a Moving Picture Experts Group Audio Layer III (MP3) player, a Moving Picture Experts Group Audio Layer IV (MP4) player, a notebook computer, or a desktop computer. The terminal 1100 may also be referred to as another name such as user equipment, a portable terminal, a laptop terminal, or a desktop terminal.

Generally, the terminal 1100 includes one or more processors 1101 and one or more memories 1102.

The processor 1101 may include processing circuitry such as one or more processing cores, for example, a 4-core processor or an 8-core processor. The processor 1101 may be implemented in at least one hardware form of processing circuitry such as a digital signal processor (DSP), a field-programmable gate array (FPGA), and a programmable logic array (PLA). The processor 1101 may also include a main processor and a coprocessor. The main processor is a processor configured to process data in an awake state, and is also referred to as a central processing unit (CPU). The coprocessor is a low power consumption processor configured to process the data in a standby state. In some embodiments, the processor 1101 may be integrated with a graphics processing unit (GPU). The GPU is configured to render and draw content that needs to be displayed on a display screen. In some embodiments, the processor 1101 may further include an artificial intelligence (AI) processor. The AI processor is configured to process computing operations related to machine learning.

The memory 1102 may include one or more computer-readable storage media. The computer-readable storage medium may be non-transitory. The memory 1102 may further include a high-speed random access memory and a nonvolatile memory, for example, one or more disk storage devices or flash storage devices. In some embodiments, the non-transitory computer-readable storage medium in the memory 1102 is configured to store at least one instruction, and the at least one instruction being configured to be executed by the processor 1101 to implement the method for obtaining a position of a target provided in the method embodiments of the present disclosure.

In some embodiments, the terminal 1100 may alternatively include: a peripheral interface 1103 and at least one peripheral. The processor 1101, the memory 1102, and the peripheral interface 1103 may be connected through a bus or a signal cable. Each peripheral may be connected to the peripheral interface 1103 through a bus, a signal cable, or a circuit board. Specifically, the peripheral includes: at least one of a radio frequency (RF) circuit 1104, a display screen 1105, a camera component 1106, an audio circuit 1107, a positioning component 1108, and a power supply 1109.

The peripheral interface 1103 may be configured to connect the at least one peripheral related to input/output (I/O) to the processor 1101 and the memory 1102. In some embodiments, the processor 1101, the memory 1102 and the peripheral device interface 1103 are integrated on the same chip or circuit board. In some other embodiments, any one or two of the processor 1101, the memory 1102, and the peripheral device interface 1103 may be implemented on a single chip or circuit board. This is not limited in this embodiment.

The RF circuit 1104 is configured to receive and transmit an RF signal, also referred to as an electromagnetic signal. The RF circuit 1104 communicates with a communication network and other communication devices through the electromagnetic signal. The RF circuit 1104 converts an electrical signal into an electromagnetic signal for transmission, or converts a received electromagnetic signal into an electrical signal. In some embodiments, the RF circuit 1104 includes: an antenna system, an RF transceiver, one or more amplifiers, a tuner, an oscillator, a digital signal processor, a codec chip set, a subscriber identity module card, and the like. The RF circuit 1104 may communicate with another terminal by using at least one wireless communication protocol. The wireless communication protocol includes, but is not limited to, a metropolitan area network, generations of mobile communication networks (2G, 3G, 4G, and 5G), a wireless local area network, and/or a Wi-Fi network. In some embodiments, the RF 1104 may further include a circuit related to NFC, which is not limited in the present disclosure.

The display screen 1105 is configured to display a user interface (UI). The UI may include a graph, text, an icon, a video, and any combination thereof. When the display screen 1105 is a touch display screen, the display screen 1105 further has a capability of acquiring a touch signal on or above a surface of the display screen 1105. The touch signal may be inputted to the processor 1101 as a control signal for processing. In this case, the display screen 1105 may be further configured to provide a virtual button and/or a virtual keyboard that are/is also referred to as a soft button and/or a soft keyboard. In some embodiments, there may be one display screen 1105, disposed on a front panel of the terminal 1100. In some other embodiments, there may be at least two display screens 1105, respectively disposed on different surfaces of the terminal 1100 or designed in a foldable shape. In still some other embodiments, the display screen 1105 may be a flexible display screen, disposed on a curved surface or a folded surface of the terminal 1100. Even, the display screen 1105 may be further set in a non-rectangular irregular pattern, namely, a special-shaped screen. The display screen 1105 may be prepared by using materials such as a liquid crystal display (LCD), an organic light-emitting diode (OLED), or the like.

The camera component 1106 is configured to capture images or videos. In some embodiments, the camera component 1106 includes a front-facing camera and a rear-facing camera. Generally, the front-facing camera is disposed on the front panel of the terminal, and the rear-facing camera is disposed on a back surface of the terminal. In some embodiments, there are at least two rear cameras, which are respectively any of a main camera, a depth-of-field camera, a wide-angle camera, and a telephoto camera, to achieve background blur through fusion of the main camera and the depth-of-field camera, panoramic photographing and virtual reality (VR) photographing through fusion of the main camera and the wide-angle camera, or other fusion photographing functions. In some embodiments, the camera component 1106 may further include a flash. The flash may be a monochrome temperature flash, or may be a double color temperature flash. The double color temperature flash refers to a combination of a warm light flash and a cold light flash, and may be used for light compensation under different color temperatures.

The audio circuit 1107 may include a microphone and a speaker. The microphone is configured to acquire sound waves of a user and an environment, and convert the sound waves into an electrical signal to input to the processor 1101 for processing, or input to the radio frequency circuit 1104 for implementing voice communication. For the purpose of stereo acquisition or noise reduction, there may be a plurality of microphones, respectively disposed at different portions of the terminal 1100. The microphone may further be an array microphone or an omni-directional acquisition type microphone. The speaker is configured to convert electric signals from the processor 1101 or the RF circuit 1104 into sound waves. The speaker may be a conventional film speaker, or may be a piezoelectric ceramic speaker. When the speaker is the piezoelectric ceramic speaker, the speaker not only can convert an electric signal into acoustic waves audible to a human being, but also can convert an electric signal into acoustic waves inaudible to a human being, for ranging and other purposes. In some embodiments, the audio circuit 1107 may further include an earphone jack.

The positioning component 1108 is configured to determine a current geographic location of the terminal 1100, to implement a navigation or a location based service (LBS). The positioning component 1108 may be a positioning component based on the Global Positioning System (GPS) of the United States, the BeiDou system of China, the GLONASS System of Russia, or the GALILEO System of the European Union.

The power supply 1109 is configured to supply power to components in the terminal 1100. The power supply 1109 may be an alternating current, a direct current, a primary battery, or a rechargeable battery. When the power supply 1109 includes the rechargeable battery, the rechargeable battery may support wired charging or wireless charging. The rechargeable battery may be further configured to support a fast charging technology.

In some embodiments, the terminal 1100 further includes one or more sensors 1110. The one or more sensors 1110 include, but are not limited to: an acceleration sensor 1111, a gyroscope sensor 1112, a pressure sensor 1113, a fingerprint sensor 1114, an optical sensor 1115, and a proximity sensor 1116.

The acceleration sensor 1111 may detect a magnitude of acceleration on three coordinate axes of a coordinate system established with the terminal 1100. For example, the acceleration sensor 1111 may be configured to detect components of gravity acceleration on the three coordinate axes. The processor 1101 may control, according to a gravity acceleration signal collected by the acceleration sensor 1111, the display screen 1105 to display the user interface in a frame view or a portrait view. The acceleration sensor 1111 may be further configured to acquire motion data of a game or a user.

The gyroscope sensor 1112 may detect a body direction and a rotation angle of the terminal 1100. The gyroscope sensor 1112 may cooperate with the acceleration sensor 1111 to acquire a 3D action by the user on the terminal 1100. The processor 1101 may implement the following functions according to the data acquired by the gyroscope sensor 1112: motion sensing (e.g., changing the UI according to a tilt operation of the user), image stabilization at shooting, game control, and inertial navigation.

The pressure sensor 1113 may be disposed at a side frame of the terminal 1100 and/or a lower layer of the display screen 1105. When the pressure sensor 1113 is disposed at the side frame of the terminal 1100, a holding signal of the user on the terminal 1100 may be detected. The processor 1101 performs left and right hand recognition or a quick operation according to the holding signal acquired by the pressure sensor 1113. When the pressure sensor 1113 is disposed on the low layer of the display screen 1105, the processor 1101 controls, according to a pressure operation of the user on the display screen 1105, an operable control on the UI. The operable control includes at least one of a button control, a scroll-bar control, an icon control, and a menu control.

The fingerprint sensor 1114 is configured to acquire a user's fingerprint, and the processor 1101 identifies a user's identity according to the fingerprint acquired by the fingerprint sensor 1114, or the fingerprint sensor 1114 identifies a user's identity according to the acquired fingerprint. When identifying that the user's identity is a trusted identity, the processor 1101 authorizes the user to perform related sensitive operations. The sensitive operations include: unlocking a screen, viewing encrypted information, downloading software, paying, changing a setting, and the like. The fingerprint sensor 1114 may be disposed on a front surface, a back surface, or a side surface of the terminal 1100. When a physical button or a vendor logo is disposed on the terminal 1100, the fingerprint sensor 1114 may be integrated with the physical button or the vendor logo.

The optical sensor 1115 is configured to acquire ambient light intensity. In an embodiment, the processor 1101 may control display luminance of the display screen 1105 according to the ambient light intensity collected by the optical sensor 1115. For example, when the ambient light intensity is relatively high, the display luminance of the display screen 1105 is increased. When the ambient light intensity is relatively low, the display luminance of the display screen 1105 is reduced. In another embodiment, the processor 1101 may further dynamically adjust a camera parameter of the camera component 1106 according to the ambient light intensity acquired by the optical sensor 1115.

The proximity sensor 1116, also referred to as a distance sensor, is usually disposed on the front panel of the terminal 1100. The proximity sensor 1116 is configured to acquire a distance between the user and the front surface of the terminal 1100. In an embodiment, when the proximity sensor 1116 detects that the distance between the user and the front surface of the terminal 1100 gradually becomes smaller, the display screen 1105 is controlled by the processor 1101 to switch from a screen-on state to a screen-off state. When the proximity sensor 1116 detects that the distance between the user and the front surface of the terminal 1100 gradually becomes larger, the display screen 1105 is controlled by the processor 1101 to switch from the screen-off state to the screen-on state.

A person skilled in the art may understand that the structure shown in FIG. 11 is not intended to limit the terminal 1100 to specific embodiments, and the terminal may include more or fewer components than those shown in the figure, or some components may be combined, or a different component deployment may be used.

FIG. 12 is a schematic structural diagram of a server according to an embodiment of the present disclosure. The server 1200 may vary greatly because a configuration or performance varies, and may include one or more central processing units (CPU) 1201 and one or more memories 1202. The one or more memories 1202 store at least one instruction, and the at least one instruction is loaded and executed by the one or more processors 1201 to implement the method for obtaining a position of a target provided in the foregoing various method embodiments. The server 1200 may also have a wired or wireless network interface, a keyboard, an input/output interface and other components to facilitate input/output. The server 1200 may also include other components for implementing device functions. Details are not described herein.

In an exemplary embodiment, a computer-readable storage medium such as a non-transitory computer-readable storage medium is further provided, for example, a memory including instructions. The instructions may be executed by a processor to complete the method for obtaining a position of a target in the foregoing embodiments. For example, the computer-readable storage medium may be a read-only memory (ROM), a RAM, a compact disc ROM (CD-ROM), a magnetic tape, a floppy disk, an optical data storage device, or the like.

A person of ordinary skill in the art may understand that all or some of the steps of the foregoing embodiments may be implemented by hardware, or may be implemented by a program instructing relevant hardware. The program may be stored in a computer-readable storage medium. The storage medium may be a read-only memory, a magnetic disk, an optical disc, or the like.

The foregoing descriptions are merely exemplary embodiments of the present disclosure and are not intended to limit the present disclosure. Any modification, equivalent replacement, and improvement made without departing from the spirit and principle of the present disclosure shall fall within the protection scope of the present disclosure.

What is claimed is:

1. A method for obtaining a position of a target, the method comprising:
receiving a plurality of frames of images, a first image in the plurality of frames of images including a to-be-detected target;
invoking a position obtaining model, a model parameter of the position obtaining model being obtained through training based on a first position of a selected target in a first sample image in a plurality of frames of sample images and a second position of the selected target in the first sample image, the second position being predicted based on a third position of the selected target in a second sample image in the plurality of frames of sample images, the third position being predicted based on the first position, the second sample image being different from the first sample image in the plurality of frames of sample images; and
determining, by processing circuitry, a position of the to-be-detected target in a second image based on the model parameter and a position of the to-be-detected target in the first image via the position obtaining model, the second image being different from the first image in the plurality of frames of images.

2. The method according to claim 1, wherein the determining comprises:
determining an image processing parameter based on the position of the to-be-detected target in the first image, the first image, and the model parameter; and
processing the second image based on the image processing parameter, to determine the position of the to-be-detected target in the second image.

3. The method according to claim 2, wherein
the determining the image processing parameter comprises:
generating position indication information corresponding to the first image based on the position of the to-be-detected target in the first image, the position indication information corresponding to the first image indicating a selected position of the to-be-detected target in the first image; and
determining the image processing parameter based on the position indication information corresponding to the first image, the first image, and the model parameter; and
the processing the second image includes processing the second image based on the image processing parameter, to determine position indication information corresponding to the second image, the position indication information corresponding to the second image indicating a predicted position of the to-be-detected target in the second image.

4. The method according to claim 3, wherein
the determining the image processing parameter based on the position indication information comprises:
performing feature extraction on the first image based on the model parameter, to obtain an image feature of the first image; and
determining the image processing parameter based on the image feature of the first image and the position indication information corresponding to the first image; and
the processing the second image based on the image processing parameter, to determine the position indication information comprises:
performing feature extraction on the second image based on the model parameter, to obtain an image feature of the second image; and
processing the image feature of the second image based on the image processing parameter, to determine the position indication information corresponding to the second image.

5. The method according to claim 1, wherein a training process of the position obtaining model comprises:
obtaining a plurality of frames of sample images;
invoking an initial model, randomly selecting, by using the initial model, a target area in the first sample image in the plurality of frames of sample images as the selected target, obtaining the third position of the selected target in the second sample image based on the first position of the selected target in the first sample image, the first sample image, and the second sample image, and obtaining the second position of the selected target in the first sample image based on the third position of the selected target in the second sample image, the first sample image, and the second sample image;
obtaining an error value of the second position relative to the first position based on the first position and the second position of the selected target in the first sample image; and
adjusting a model parameter of the initial model based on the error value until a target condition is met, to obtain the position obtaining model.

6. The method according to claim 5, wherein
the obtaining the third position of the selected target in the second sample image includes:
obtaining a first image processing parameter based on the first position and the first sample image; and
processing the second sample image based on the first image processing parameter, to obtain the third position; and
the obtaining the second position of the selected target in the first sample image includes:
obtaining a second image processing parameter based on the third position and the second sample image; and
processing the first sample image based on the second image processing parameter, to obtain the second position.

7. The method according to claim 6, wherein
the obtaining the first image processing parameter includes:
performing feature extraction on the first sample image based on the model parameter of the initial model, to obtain an image feature of the first sample image; and
obtaining the first image processing parameter based on the image feature of the first sample image and the first position; and
the processing the second sample image includes:
performing feature extraction on the second sample image based on the model parameter of the initial model, to obtain an image feature of the second sample image; and
processing the image feature of the second sample image based on the first image processing parameter, to obtain the third position.

8. The method according to claim 5, wherein
the obtaining the third position of the selected target in the second sample image includes:
generating first position indication information corresponding to the first sample image based on the first position, the first position indication information indicating a selected position of the selected target in the first sample image; and
obtaining position indication information corresponding to the second sample image based on the first position indication information, the first sample image, and the second sample image, the position indication information corresponding to the second sample image indicating a predicted position of the selected target in the second sample image; and
the obtaining the second position of the selected target in the first sample image includes obtaining second position indication information corresponding to the first sample image based on the position indication information corresponding to the second sample image, the first sample image, and the second sample image, the second position indication information indicating a predicted position of the selected target in the first sample image.

9. The method according to claim 5, wherein the plurality of frames of sample images includes a plurality of sample image sets, each of the sample image sets includes a first sample image and at least a second sample image, and each of the sample image sets corresponds to one error value; and
the adjusting the model parameter of the initial model includes adjusting, for each target quantity of sample image sets in the plurality of sample image sets, the model parameter of the initial model based on the plurality of error values corresponding to the target quantity of sample image sets.

10. The method according to claim 9, wherein the adjusting the model parameter of the initial model based on a plurality of error values comprises any one of the following:
removing error values meeting an error value condition in the plurality of error values based on the plurality of error values corresponding to the target quantity of sample image sets; and adjusting the model parameter of the initial model based on the remaining error values; or
determining first weights of the plurality of error values based on the plurality of error values corresponding to the target quantity of sample image sets; and adjusting the model parameter of the initial model based on the first weights of the plurality of error values and the plurality of error values, the first weights of error values meeting an error value condition in the plurality of error values being zero.

11. The method according to claim 9, wherein
each of the sample image sets corresponds to a second weight; and
the adjusting the model parameter of the initial model based on the plurality of error values includes:
obtaining the second weight of the error value of each of the sample image sets, the second weight being positively correlated with a displacement of the selected target in the plurality of frames of sample images in the respective sample image set; and
adjusting the model parameter of the initial model based on the plurality of error values and the plurality of second weights corresponding to the target quantity of sample image sets.

12. A method for obtaining a position of a target, the method comprising:
obtaining a plurality of frames of sample images;
invoking an initial model, obtaining, based on a first position of a selected target in a first sample image in the plurality of frames of sample images according to the initial model, a third position of the selected target in a second sample image, obtaining a second position of the selected target in the first sample image based on the third position of the selected target in the second sample image, and adjusting a model parameter of the initial model based on the first position and the second position, to obtain a position obtaining model, the selected target being obtained by randomly selecting a target area in the first sample image by the initial model, the second sample image being different from the first sample image in the plurality of frames of sample images; and
invoking the position obtaining model when a plurality of frames of images is obtained, and determining positions of a to-be-detected target in the plurality of frames of images according to the position obtaining model.

13. An apparatus, comprising:
processing circuitry configured to:
receive a plurality of frames of images, a first image in the plurality of frames of images including a to-be-detected target;
invoke a position obtaining model, a model parameter of the position obtaining model being obtained through training based on a first position of a selected target in a first sample image in a plurality of frames of sample images and a second position of the selected target in the first sample image, the second position being predicted based on a third position of the selected target in a second sample image in the plurality of frames of sample images, the third position being predicted based on the first position, the second sample image being different from the first sample image in the plurality of frames of sample images; and
determine a position of the to-be-detected target in a second image based on the model parameter and a position of the to-be-detected target in the first image via the position obtaining model, the second image being different from the first image in the plurality of frames of images.

14. The apparatus according to claim 13, wherein the processing circuitry is configured to:
determine an image processing parameter based on the position of the to-be-detected target in the first image, the first image, and the model parameter; and
process the second image based on the image processing parameter, to determine the position of the to-be-detected target in the second image.

15. The apparatus according to claim 14, wherein the processing circuitry is configured to:
generate position indication information corresponding to the first image based on the position of the to-be-detected target in the first image, the position indication information corresponding to the first image indicating a selected position of the to-be-detected target in the first image;
determine the image processing parameter based on the position indication information corresponding to the first image, the first image, and the model parameter; and
process the second image based on the image processing parameter, to determine position indication information corresponding to the second image, the position indication information corresponding to the second image indicating a predicted position of the to-be-detected target in the second image.

16. The apparatus according to claim 15, wherein the processing circuitry is configured to:
perform feature extraction on the first image based on the model parameter, to obtain an image feature of the first image;
determine the image processing parameter based on the image feature of the first image and the position indication information corresponding to the first image;
perform feature extraction on the second image based on the model parameter, to obtain an image feature of the second image; and
process the image feature of the second image based on the image processing parameter, to determine the position indication information corresponding to the second image.

17. The apparatus according to claim 13, wherein in a training process of the position obtaining model,
a plurality of frames of sample images is obtained;
an initial model is invoked, a target area in the first sample image in the plurality of frames of sample images is randomly selected, by using the initial model, as the selected target, the third position of the selected target in the second sample image is obtained based on the first position of the selected target in the first sample image, the first sample image, and the second sample image, and the second position of the selected target in the first sample image is obtained based on the third position of the selected target in the second sample image, the first sample image, and the second sample image;
an error value of the second position relative to the first position is obtained based on the first position and the second position of the selected target in the first sample image; and
a model parameter of the initial model is adjusted based on the error value until a target condition is met, to obtain the position obtaining model.

18. The apparatus according to claim 17, wherein
the third position of the selected target in the second sample image is obtained by
obtaining a first image processing parameter based on the first position and the first sample image; and
processing the second sample image based on the first image processing parameter, to obtain the third position; and
the second position of the selected target in the first sample image is obtained by
obtaining a second image processing parameter based on the third position and the second sample image; and
processing the first sample image based on the second image processing parameter, to obtain the second position.

19. A non-transitory computer-readable storage medium storing instructions which when executed by a processor cause the processor to perform the method according to claim 1.

20. A non-transitory computer-readable storage medium storing instructions which when executed by a processor cause the processor to perform the method according to claim 12.
